(19) United States
(12) Patent Application Publication
(10) Pub. No.: US 2009/0083746 A1
(43) Pub. Date: Mar. 26, 2009

(54) METHOD FOR JOB MANAGEMENT OF COMPUTER SYSTEM

(75) Inventor: Akira KATSUMATA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kanagawa (JP)

(21) Appl. No.: 12/209,531

(22) Filed: Sep. 12, 2008

(30) Foreign Application Priority Data
Sep. 21, 2007 (JP) 2007-245741

(51) Int. Cl. G06F 9/46

(52) U.S. Cl. 718/103

(57) ABSTRACT

A method for job management of a computer system, a job management system, and a computer-readable recording medium are provided. The method includes selecting, as a second job, a running job which is lower in priority than a first job and a number of computing nodes required for execution of which is not smaller than a deficient number of computing nodes due to execution of the first job when a number of free computing nodes in a cluster of the computer system is smaller than a number of computing nodes required for the first job, suspending all processes of the second job and executing the first job in the computing nodes which were used by the second job and the free computing nodes, and resuming execution of the second job after execution of the first job is completed.

### CROSS-REFERENCE TO RELATED APPLICATIONS

This application is related to and claims priority to prior Japanese Patent Application No. 2007-245741 filed on Sep. 21, 2007 and incorporated herein by reference.

### BACKGROUND

1. Field

An embodiments discussed herein are directed to a job management method, a job management apparatus and a job management program for managing a job to be executed on a cluster including a plurality of computing nodes.

2. Description of the Related Art

A computer cluster (hereinafter refer to as “cluster”) made up of a combination of computing nodes is used for execution of a job requiring a great deal of computing power such as a job of scientific and technical computation. In an information processing environment having such a cluster, a job management apparatus for managing assignment of a job to computing nodes is provided in order to use the respective computing nodes efficiently.

Generally, a job to be executed in the cluster is configured to be executed by parallel processing on a predetermined number of computing nodes to achieve an aim in a short time. When a new job is input in the job management apparatus, the job management apparatus reserves an exact number of computing nodes required for the job and assigns the reserved computing nodes to the job. When the total number of computing nodes required for input jobs exceeds the number of computing nodes constituting the cluster, the job management apparatus assigns the computing nodes to high-priority jobs in order of priority.

For example, a conventional job management apparatus (schedule control apparatus) operates as follows. When a high-priority job is newly input in the job management apparatus but a sufficient number of unused computing nodes (hereinafter referred to as “free nodes”) required for the job cannot be reserved in the cluster, the job management apparatus suspends execution of processes of low-priority jobs among running processes and reassigns computing nodes used in the processes of the low-priority jobs to the high-priority job newly input in the job management apparatus.

The conventional job management apparatus, however, selects processes of low-priority jobs at random and suspends execution of the processes when a high-priority job is input newly in the job management apparatus. For this reason, there is a problem that computing nodes cannot be used effectively after execution of the processes of the low-priority jobs is suspended.

Specifically, some of jobs to be executed in the cluster are jobs of the type whose processes are carried on while information is exchanged among a plurality of computing nodes. When execution of a process of this type job executed on a certain computing node is suspended for some reason, execution of the other processes of the same job executed on other computing nodes cannot be continued because the other processes of the same job cannot exchange information with the suspended process, that is, the other processes of the same job get into a state substantially equal to a suspended state.

For example, assume that a running job A has processes that are carried on while information is exchanged among four computing nodes. Assume further that with the input of a high-priority job B requiring use of one computing node, one process executed on one of the four computing nodes is suspended and this computing node is assigned to the job B. In this case, the processes on the remaining three computing nodes for execution of the job A cannot exchange information with the suspended process. As a result, the processes on the remaining three computing nodes substantially get into a suspended state, so that the three computing nodes cannot be used effectively.

### SUMMARY

According to an aspect of an embodiment, a method for job management of a computer system by a computer, includes selecting, as a second job, a running job that is lower in priority than a first job and a number of computing nodes required for execution of that is not smaller than a deficient number of computing nodes due to execution of the first job when a number of free computing nodes in a cluster of the computer system is smaller than a number of computing nodes required for the first job, suspending all processes of the second job and executing the first job in the computing nodes that were used by the second job and the free computing nodes, and resuming execution of the second job after execution of the first job is completed.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates a cluster system for executing job management according to an embodiment;

FIG. 2 illustrates an outline according to an embodiment;

FIG. 3 illustrates exemplary processing in which a combination of jobs is suspended;

FIG. 4 illustrates exemplary processing in which computing nodes to be suspended are selected so that a total amount of idle times of computing nodes is shortest;

FIG. 5 illustrates an exemplary job management apparatus;

FIG. 6A illustrates job management information;

FIG. 6B illustrates job management information after a high-priority job has been input;

FIG. 7 illustrates job assignment information;

FIG. 8 illustrates an output screen of a simulation portion;

FIG. 9 illustrates a processing procedure of acceptance when a new job is input into the job management apparatus;

FIG. 10 illustrates a processing procedure of a suspended job selection process;

FIG. 11 illustrates a processing procedure of a free node-using job selection process;

FIG. 12 illustrates a processing procedure of an execution control portion;

FIG. 13 illustrates a processing procedure of a queued job monitoring process;

FIG. 14 illustrates a processing procedure of an running job monitoring process; and

FIG. 15 illustrates a computer for executing a job management program.

### DETAILED DESCRIPTION OF AN EMBODIMENTS

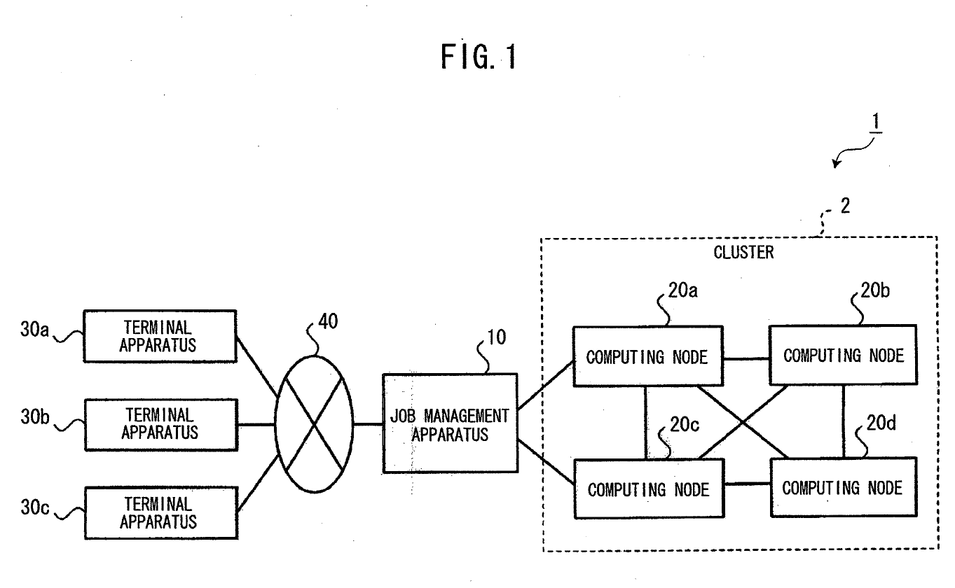

An outline of job management according to an embodiment will be described. FIG. 1 illustrates an example of a cluster system in which the job management method according to an embodiment is executed. As illustrated in FIG. 1, the cluster system 1 includes a cluster 2, a job management apparatus 10, and terminal apparatuses 30a to 30c.

The cluster 2 is a computer group made up of a combination of computing nodes 20a to 20d. Although FIG. 1 illustrates cluster 2 includes four computing nodes, cluster 2 may include an arbitrary number of computing nodes. The computing power of the cluster 2 increases as the number of computing nodes included in the cluster 2 increases. For example, the cluster 2 may be made up of a combination of one hundred or more computing nodes.

The job management apparatus 10 is an apparatus which accepts jobs to be executed in the cluster 2 from the terminal apparatuses 30a to 30c and schedules assignment of the accepted jobs to the computing nodes 20a to 20d. Priority and the number of computing nodes required for execution are designated in advance for each of the jobs accepted by the job management apparatus 10. The job management apparatus 10 performs scheduling based on these pieces of information so that the computing nodes 20a to 20d can be used as effectively as possible. The term “job” may be defined as a unit of processing formed for a predetermined object. The job may have one or a plurality of executable programs, a script for controlling execution of these programs, data required for execution of these programs, etc. For example, a scientific and technical computation process requiring a great deal of computation time, a transaction-related monthly batch process, a three-dimensional image generating process based on three-dimensional data, or the like, corresponds to the job in this specification.

The terminal apparatuses 30a to 30c are apparatuses which request the job management apparatus 10 to execute jobs and acquire results of the execution from the job management apparatus 10. The terminal apparatuses 30a to 30c may be connected to the job management apparatus 10 by a network 40.

Cluster system 1 is an example generally showing a cluster system. A job management method, including a conventional method, can be also executed in the same environment. Any form can be used as the true form of the computing nodes 20a to 20d as long as arithmetic operations can be executed independently. For example, each of the computing nodes 20a to 20d may be an information processing apparatus having an independent housing, may be one of CPUs provided in a multiprocessor type information processing apparatus, may be one core on a multicore type CPU, or may be a virtual computer implemented by software.

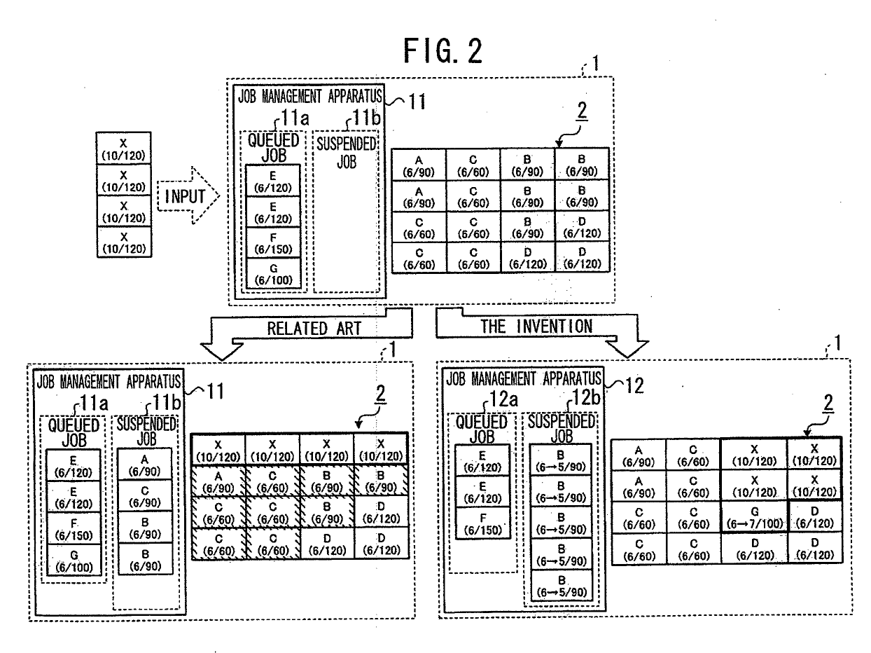

FIG. 2 illustrates the outline of the job management according to an embodiment. FIG. 2 illustrates a situation that a high-priority job X is input into a cluster system 1. In FIG. 2, the cluster system 1 includes a cluster 2 made up of a combination of 16 computing nodes, and a job management apparatus 11. The job management apparatus 11 is an apparatus for executing a job management method. The job management apparatus 11 includes a queued job storage area 11a, and a suspended job storage area 11b. The queued job storage area 11a holds jobs which are input into the job management apparatus 11 but are not assigned to the computing nodes yet. The suspended job storage area 11b holds jobs which are in a suspended state.

In FIG. 2, jobs are expressed in rectangles provided in the cluster 2, the queued job storage area 11a and the suspended job storage area 11b. Specifically, the number of rectangles expresses the number of computing nodes required for the jobs. In each rectangle, a character in the upper part expresses the name of a job, and a number in front of “/” and a number in rear of “/” in the lower part express priority of the job and time required for execution of the job, respectively. The priority in this embodiment takes any value of 1 to 10. The larger the value is, the higher the priority is. In addition, the time required for execution is an estimated value of time required from the start of execution to the end of execution. The time required for execution is expressed in minute.

In the cluster system 1 in FIG. 2, two computing nodes are used for execution of processes of a job A with priority “6” and time “90 min” required for execution, five computing nodes are used for execution of processes of a job B with priority “6” and time “90 min” required for execution, six computing nodes are used for execution of processes of a job C with priority “6” and time “60 min” required for execution, and three computing nodes are used for execution of processes of a job D with priority “6” and time “120 min” required for execution.

In addition, the queued job storage area 11a holds a job E with priority “6” and time “120 min” required for execution, requiring two computing nodes, a job F with priority “6” and time “150 min” required for execution, requiring one computing node, and a job G with priority “6” and time “100 min” required for execution, requiring one computing node while the suspended job storage area 11b is empty.

When a high-priority job X with priority “10” and time “120 min” required for execution, requiring four computing nodes is input into the job management apparatus 11 on this occasion, the job management apparatus 11 selects four computing nodes required for the job X from the cluster 2 and suspends processes executed on the computer nodes in order to execute the job X with priority. The job management apparatus 11 reassigns the computing nodes used for the suspended processes to the job X for execution of the job X.

In the example illustrated in FIG. 2, one computing node assigned to the job A, one computing node assigned to the job C and two computing nodes assigned to the job B are reassigned to the job X in order to execute the job X with priority. In this manner, in the job management, even when there is no free node required for a high-priority job X when the job X is input newly, computing nodes required for the job X can be reserved if processes carried out on computing nodes used for jobs with lower priority than the job X are suspended.

The job management apparatus 11, however, selects running processes to be suspended without taking into consideration whether or not each running process is a process of the type which is carried on while exchanging information with another process of the same job executed on another computing node. For this reason, when, for example, the job A, the job B and the job C are jobs of the type whose processes are carried on while information is exchanged among assigned computing nodes in the example of FIG. 2, processes of the jobs A, B and C which are not suspended cannot go further because the processes which are not suspended cannot exchange information with the suspended processes, so that the processes which are not suspended are brought into a state substantially equal to a suspended state. Thus, nine computing nodes represented by the oblique lines cannot be used effectively.

In order to solve such a problem, job management according to an embodiment collectively suspends running processes of one and the same job executed in parallel processing while taking into consideration effective use of respective computing nodes when a high-priority job is input but there is no free node required for the high-priority job.

A job management apparatus 12 in FIG. 2 is an apparatus for executing the job management according to an embodiment. The job management apparatus 12 includes a queued job storage area 12a and a suspended job storage area 12b in place of the queued job storage area 11a and the suspended job storage area 11b.

As illustrated in FIG. 2, when a high-priority job X with priority “10” and time “120 min” required for execution, requiring four computing nodes is input into the job management apparatus 12, the job management apparatus 12 selects a job to be suspended from running jobs in the cluster 2 in order to execute the job X with priority. As the job to be suspended, the lowest-priority job is selected from jobs which are lower in priority than the job X and to each of which the number of computing nodes not smaller than the number of computing nodes deficient for execution of the job X are assigned. When there are jobs as candidates, a job smallest in number of assigned computing nodes is selected from the candidates.

In the example illustrated in FIG. 2, a job B to which five computing nodes are assigned is selected as the job to be suspended. In this example, since the deficient number of computing nodes for execution of the newly input high-priority job X is four whereas the priority for the job B to which five computing nodes are assigned and the job C to which six computing nodes are assigned is “6”, the two jobs B and C are candidates of the job to be suspended. The reason why the job B is selected, as the job to be suspended, from the two jobs B and C is that the number of computing nodes assigned to the job B is smaller.

As described above, the reason why a job, to which a number of computing nodes not smaller than the deficient number of computing nodes for a high-priority job are assigned, is selected as the job to be suspended in order to execute the high-priority job is to prevent occurrence of a situation where processes executed on part of computing nodes assigned to a job are suspended and other processes of the same job exchanging information with the suspended processes are occupied by the remaining computing nodes but brought into a state substantially equal to a suspended state so that the computing nodes cannot be used effectively.

Moreover, the reason why a job smallest in number of assigned computing nodes is selected, when there are candidates of the job to be suspended, is that an overhead required for suspension is minimized. That is, minimizing overhead required for dumping a memory image of running processes into a file and transferring the file to the suspended job storage area 12b of the job management apparatus 12 to achieve a suspended state.

When the job B to which five computing nodes are assigned is suspended and the job X requiring four computing nodes is executed in this manner, one computing node becomes free. To use such free nodes effectively, a job the number of computing nodes required for execution of which is not larger than the number of free nodes and the time required for execution of which is not longer than the time required for execution of the job X is selected from queued jobs held in the queued job storage area 12a and the free nodes are assigned to the selected job in the job management according to an embodiment. When there are jobs as candidates, a job which can use the free nodes more effectively is selected, i.e. a job is selected so that the total amount of idle times of computing nodes in the cluster 2 until completion of execution of the job X becomes smallest when the free nodes are assigned to the job.

In the example illustrated in FIG. 2, the number of free nodes is 1 and the queued jobs requiring one or less computing node are the job F and the job G. Of these jobs, the time required for execution of the job F is “150 min” which exceeds the time “120 min” required for execution of the job X. Accordingly, the job G having the time “100 min” required for execution is selected as a job executed by effective use of the free node (hereinafter referred to as “free node-using job”).

The reason why the job having the time required for execution not longer than the time required for execution of the high-priority job is selected thus as a free node-using job is the suspended job can be resumed rapidly after completion of execution of the high-priority job. Description is made along with the example of FIG. 2. If the job F is selected as a free node-using job, the suspended job B cannot be resumed unless execution of the job F is completed even after completion of execution of the job X. Therefore, completion of execution of the job B is delayed and the computing nodes assigned to the job X cannot be used effectively during the period of time after completion of execution of the job X and before completion of execution of the job F. On the other hand, when the job G is selected as a free node-using job, the job B can be resumed rapidly after completion of execution of the job X and the total amount of the idle times of the computing nodes becomes short.

In the example of FIG. 2, the priority of the suspended job B is reset to be lower than the priority of any other queued job and the priority of the job G as a free node-using job is set to be higher than the priority of any other running job. This prevents a situation that part of the job B is resumed at unexpected timing or the job G is suspended because of the priority.

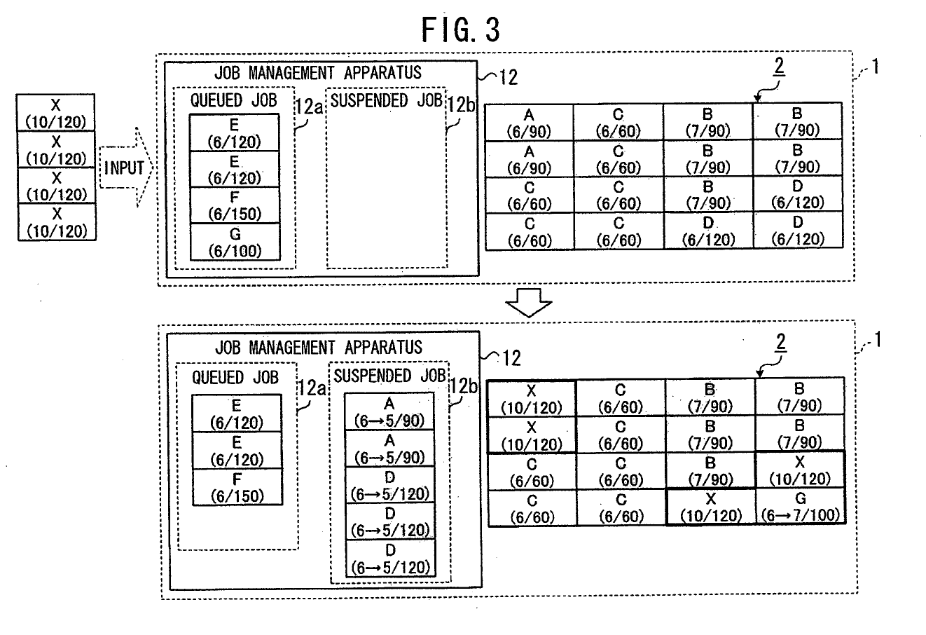

Although FIG. 2 illustrates where a single job is suspended when a high-priority job is input, a combination of jobs may be suspended instead. FIG. 3 illustrates a view showing an example of processing for suspending a combination of jobs.

In the example illustrated in FIG. 3, the job A to which two computing nodes are assigned and the job D to which three computing nodes are assigned are selected as a combination of jobs to be suspended, so that the high-priority job X requiring four computing nodes can be executed preferentially. Although the number of computing nodes assigned to the job B is 5 which is the same as the number of computing nodes assigned to the aforementioned combination, the priority of the job B is “7” which is higher than the priority “6” of the jobs A and D in the example of FIG. 3 so that the aforementioned combination is selected as a combination of jobs to be suspended.

When jobs are selected as a combination of jobs to be suspended in this manner, the jobs to be suspended can be selected flexibly. Particularly when a high-priority job requiring a large number of computing nodes is input, it may be possible that there is no single job to which a number of computing nodes not smaller than the deficient number are assigned. Even in such a case, jobs to be suspended can be selected as long as the jobs are selected as a combination of jobs to be suspended.

Incidentally, in addition to a combination of jobs to be suspended, free node-using jobs can be selected as a combination of jobs. When free node-using jobs are selected as a combination of jobs, the free node-using jobs can be selected flexibly and can be selected to further reduce the total amount of idle times of computing nodes.

Although FIG. 2 and FIG. 3 show examples in which a job or jobs are selected to minimize the process of suspending execution when a high-priority job is input, a single job or a combination of jobs may be suspended to minimize the total amount of idle times of computing nodes.

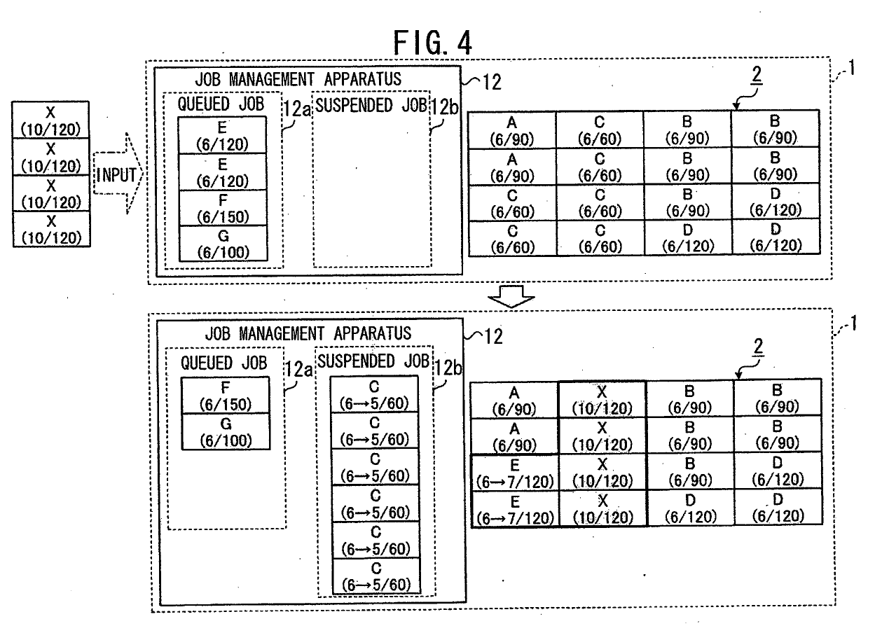

An example in which only one single job is suspended is illustrated here for simplification of description. FIG. 4 illustrates an example of processing in which a job to be suspended is selected to minimize the total amount of idle times of computing nodes. In the example illustrated in FIG. 4, the job C to which six computing nodes are assigned is selected as a job to be suspended so that the high-priority job X requiring four computing nodes can be executed preferentially.

In the example of FIG. 4, it is possible to suspend the job B to which five computing nodes are assigned. In this case, the job G having the time “100 min” required for execution is selected as a free node-using job. Accordingly, the computing node assigned to the job G has an idle time of 20 minutes in the period of time after completion of execution of the job G and before completion of execution of the job X having the time “120 min” required for execution. On the other hand, if the job C is suspended, the job E having the time “120 min” required for execution can be selected as a free node-using job. Accordingly, execution of the job E and execution of the job X are completed almost simultaneously, so that there is no idle time of computing nodes.

In this manner, when a single job or a combination of jobs are suspended to minimize the total amount of idle times of computing nodes, the computing nodes can be used effectively to the utmost.

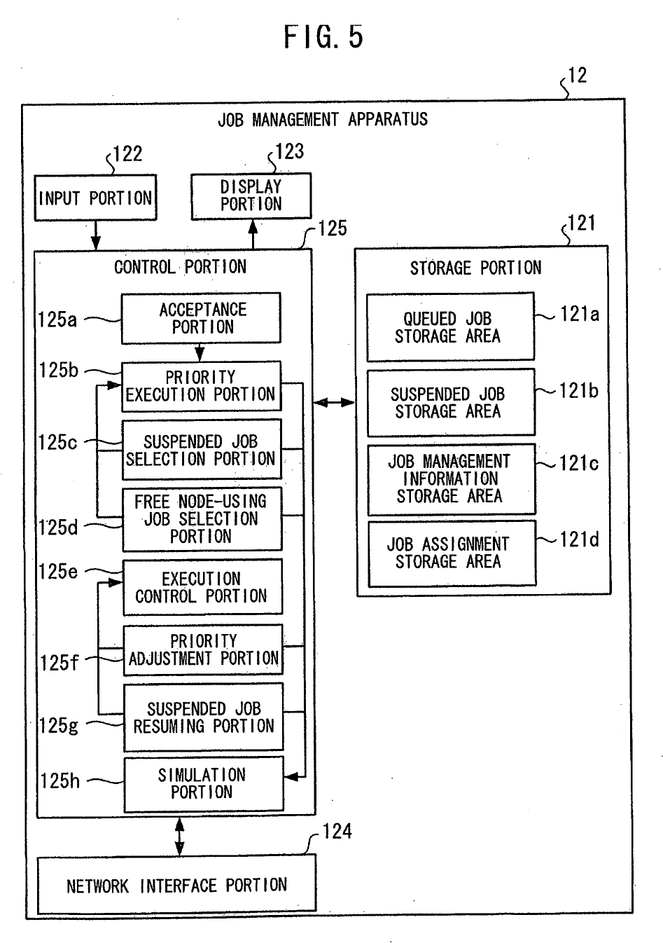

Next, the configuration of the job management apparatus 12 according to an embodiment will be described. FIG. 5 is a block diagram showing the configuration of the job management apparatus 12 according to an embodiment. As illustrated in FIG. 5, the job management apparatus 12 includes a storage portion 121, an input portion 122, a display portion 123, a network interface portion 124, and a control portion 125.

The storage portion 121 is a storage device for storing various kinds of information. The storage portion 121 includes a queued job storage area 121a, a suspended job storage area 121b, a job management information storage area 121c, and a job assignment information storage area 121d. The queued job storage area 121a is a storage area for holding any job which has been input but to which no computing node has been assigned yet. The queued job storage area 121a corresponds to the queued job storage area 12a. The suspended job storage area 121b is a storage area for holding any suspended job. The suspended job storage area 121b corresponds to the suspended job storage area 12b.

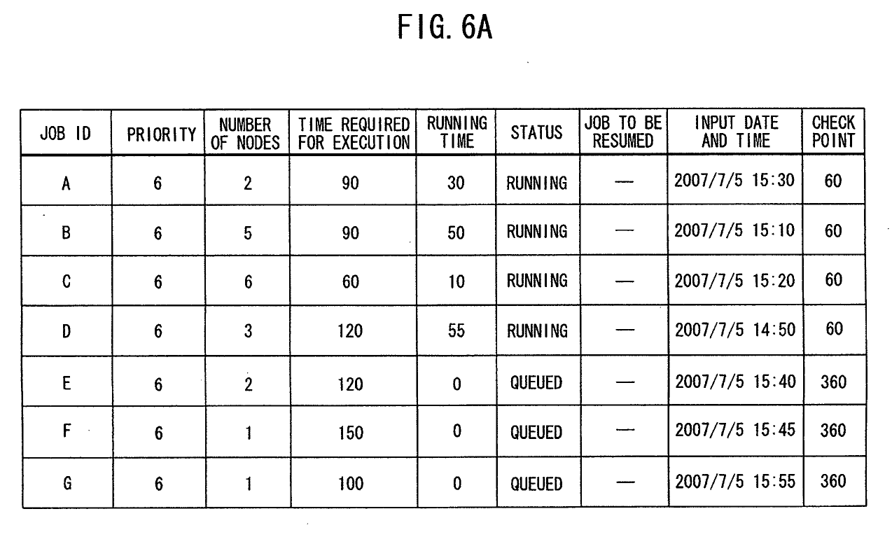

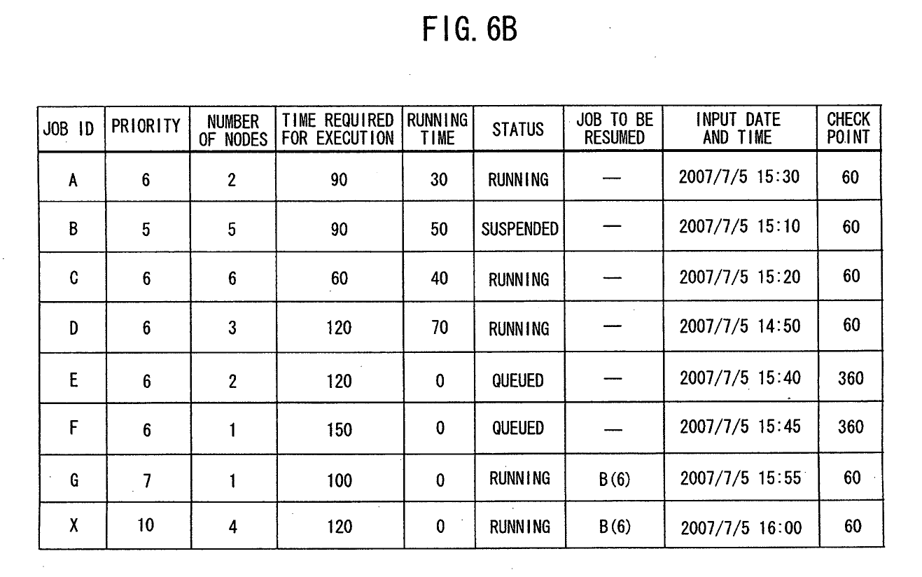

The job management information storage area 121c is a storage area for storing job management information. FIGS. 6A and 6B show an example of the job management information. The job management information is information for managing states of input jobs. The job management information includes items such as job ID, priority, number of nodes, time required for execution, running time, status, job to be resumed, input date and time, and check point. Information is stored row by row in accordance with each job.

The job ID is an identifier for identifying a job. The priority, the number of nodes and the time required for execution are parameters which are designated at the time of inputting the job and which express the priority of the job, the number of computing nodes required for execution of the job and the time (estimated time) required from start of the execution to completion of the execution, respectively. The running time is the total sum of running times of computing nodes assigned to the job.

The status expresses the state of the job and takes any state of “queued”, “running” and “suspended”. The “queued” expresses a state that the job is held in the queued job storage area 121a but there is no computing node assigned to the job. The “running” expresses a state that each computing node is assigned to the job and the job is running. The “suspended” expresses a state that the job is suspended and held in the suspended job storage area 121b.

The job to be resumed expresses the job ID and priority just before a suspended state, of a job suspended to execute the job preferentially or of a job suspended when the job is executed as a free node-using job. The input date and time is a point of time when the job was input. The check point is a value for adjusting the priority of the job. The check point will be described later in detail.

The job management information illustrated in FIG. 6A illustrates a state of each job before the job X was input in FIG. 2. Information corresponding to the job G is formed so that the job ID is “G”, the priority is “6”, the number of nodes is “1”, the time required for execution is “100”, the running time is “0”, the status is “queued”, the job to be resumed is unset, the input date and time is “2007/7/5 15:55”, and the check point is “360”.

The job management information illustrated in FIG. 6B expresses a state of each job just after the job X was input in FIG. 2. Information corresponding to the job X is registered newly. Information corresponding to the job G selected as a free node-using job is updated so that the priority is “7”, the state is “running”, the job to be resumed is “B(6)”, and the check point is “60”. The job “B(6)” to be resumed means that the job ID and priority of a job suspended when the job G is executed as a free node-using job are “B” and “6”, respectively.

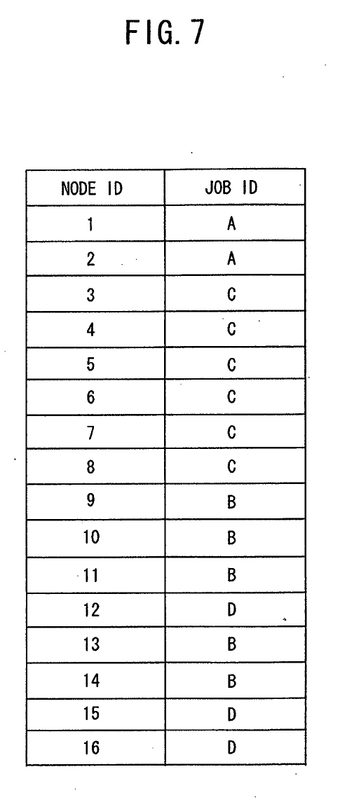

The job assignment information storage area 121d is a storage area for storing job assignment information. FIG. 7 illustrates an exemplary of the job assignment information. The job assignment information is information for managing computing node-job correspondence. The job assignment information includes items such as node ID, and job ID. The information is stored row by row in accordance with each computing node. The node ID is an identifier for identifying a computing node. The job ID is an identifier for identifying a job. The job ID corresponds to the job ID of the job management information.

The job assignment information illustrated in FIG. 7 expresses a state of each computing node before the job X was input in FIG. 2. For example, the job assignment information expresses a state that computing nodes with node IDs “1” and “2” are assigned to a job with a job ID “A”.

The input portion 122 is a device for inputting information and an operation instruction. For example, the input portion 122 includes a keyboard, and a mouse. The display portion 123 is a device for displaying various kinds of information. For example, the display portion 123 includes a liquid crystal display device. The network interface portion 124 is an interface device for achieving network communication.

The control portion 125 is a control portion for controlling the job management apparatus 12 as a whole. The control portion 125 includes an acceptance portion 125a, a priority execution portion 125b, a suspended job selection portion 125c, a free node-using job selection portion 125d, an execution control portion 125e, a priority adjustment portion 125f, a suspended job resuming portion 125g, and a simulation portion 125h.

The acceptance portion 125a is a processing portion for accepting a job execution request from each of the terminal apparatuses 30a to 30c, etc. The acceptance portion 125a stores the job contained in the accepted execution request in the queued job storage area 121a. In addition, the acceptance portion 125a accepts designation of priority and the time required for execution as attribute information of the job, adds an entry to the job management information illustrated in FIG. 6A, and sets the accepted information in the added entry.

When the accepted job is a high-priority job, the acceptance portion 125a instructs the priority execution portion 125b to execute the job preferentially. As to whether the accepted job is a high-priority job or not, for example, decision may be made that the accepted job is a high-priority job when the designated priority is not lower than a predetermined value, or decision may be made that the accepted job is a high-priority job when the designated priority is higher than that of any one of running jobs.

The priority execution portion 125b is a processing portion for controlling a node to execute a high-priority job preferentially. The priority execution portion 125b refers to the job management information to thereby check whether there are sufficient free nodes required for execution of the high-priority job. When there are sufficient free nodes, the priority execution portion 125b assigns the free nodes to the high-priority job and reflects the state in the job management information and the job assignment information.

On the other hand, when the free nodes are deficient, the priority execution portion 125b controls the suspended job selection portion 125c to select a job to be suspended. After the selected job is suspended, the priority execution portion 125b reassigns computing nodes assigned to the job to the high-priority job and reflects the state in the job management information and the job assignment information. When there are still free nodes left even after the priority execution portion 125b reassigned computing nodes to the high-priority job by referring to the job management information, the priority execution portion 125b controls the free node-using job selection portion 125d to select a free node-using job, assigns the free nodes to the selected job and reflects the state in the job management information and the job assignment information.

The suspended job selection portion 125c is a processing portion for selecting a job or jobs to be suspended in order to execute the high-priority job preferentially. The suspended job selection portion 125c selects a single job or a combination of jobs as a job or jobs to be suspended. Even when a job is running in parallel processing on computing nodes, the suspended job selection portion 125c does not make selection to suspend only a process running on part of the computing nodes.

The suspended job selection portion 125c refers to the job management information so that a single job or a combination of jobs which are lower in priority than the high-priority job to be executed preferentially and to which a number of computing nodes not smaller than the deficient number of computing nodes for preferential execution of the high-priority job are selected, as a job or jobs to be suspended, from jobs having a “running” status.

When there are candidates of the job to be suspended, a candidate smallest in number of assigned computing nodes may be selected from candidates having the lowest priority or all combinations of free node-using jobs may be checked so that a candidate which will result in the smallest total amount of idle times of computing nodes is selected, as described above.

The free node-using job selection portion 125d is a processing portion for selecting at least one free node-using job. The free node-using job selection portion 125d refers to the job management information so that a signal job or a combination of jobs which will result in the smallest total amount of idle times of computing nodes is selected as at least one free node-using job from single jobs or combinations of jobs which are in “queued” jobs, the number of computing nodes required for execution of each of which is not larger than the number of free nodes and the time required for execution of each of which is not longer than the time required for execution of the high-priority job to be executed preferentially.

The execution control portion 125e is a control portion for performing various kinds of control concerned with execution of jobs except priority execution of the high-priority job. When, for example, the execution control portion 125e periodically refers to the job assignment information and recognizes presence of at least one free node in the cluster 2, the execution control portion 125e assigns the free node(s) to a “queued” job while referring to priority, so that the state is reflected in the job management information illustrated in FIG. 6A and the job assignment information illustrated in FIG. 7.

In addition, when the execution control portion 125e periodically refers to the job management information so that the queuing time of a “queued” job, i.e. the difference between the current date and time and the input date and time is larger than a value at the check point, the execution control portion 125e instructs the priority adjustment portion 125f to reset the priority of the job at a high value to thereby adjust the job to be executed early. When the running time of a “running” job exceeds a required running time so that the difference (hereinafter referred to as “running time overrun”) is larger than a value at the check point, the execution control portion 125e instructs the priority adjustment portion 125f to reset the priority of the job at a low value to thereby adjust the job to be suspended easily.

The execution control portion 125e periodically checks the state of execution of each job and updates the value of the running time in the job management information. When there is any job execution of which is completed, the execution control portion 125e deletes information about the job from the job management information and the job assignment information. If job information has been set in the item “job to be resumed” in the entry of the job management information at that time, the execution control portion 125e delivers the information to the suspended job resuming portion 125g to thereby resume the suspended process or processes.

The priority adjustment portion 125f is a processing portion for adjusting job priority so that jobs can be executed equally. As described above, job priority may be adjusted when the queuing time of a “queued” job is not smaller than a predetermined value or when the running time overrun of a “running” job is not smaller than a predetermined value. As an example, a priority adjusting mechanism will be described on the assumption that priority may be adjusted when the queuing time exceeds a multiple of 360 min or when the running time overrun exceeds a multiple of 60 min.

When a new job is input, information about the job is registered in the job management information and “360” is set at the check point of the job management information. When the execution control portion 125e periodically refers to the job management information so that there is a “queued” job the queuing time of which has exceeded the value at the check point, the execution control portion 125e instructs the priority adjustment portion 125f to reset the priority of the job. Upon reception of the instruction, the priority adjustment portion 125f adds 1 to the priority of the designated job and adds 360 to the value at the check point so that the priority adjustment portion 125f adjusts the priority of the job again when the queuing time becomes further longer. When the priority of the job the queuing time of which becomes longer is reset at a high value in this manner, it is possible to prevent occurrence of a situation that a low-priority job cannot be executed for a long time.

In addition, when a job is brought into an execution state, the status of the job is updated to “running” and “60” is set at the check point in the job management information. When the execution control portion 125e periodically refers to the job management information so that if there is a job the status of which is “running” and the running time overrun of which exceeds the value at the check point, the execution control portion 125e instructs the priority adjustment portion 125f to reset the priority of the job. Upon reception of the instruction, the priority adjustment portion 125f subtracts 1 from the priority of the designated job and adds 60 to the value at the check point so that the priority of the job can be adjusted again when the running time overrun becomes further longer. When the priority of a job whose running time overrun becomes longer is reset at a low value in this manner, it is easy to suspend a job which has not been completed as scheduled but disturbs the schedule, so that it is possible to reduce the possibility that another job running as scheduled will be suspended to delay completion of execution.

The suspended job resuming portion 125g is a processing portion which resumes processes suspended for execution of a job when execution of the job is completed. For example, in the example of FIG. 2, the job B is suspended and the priority of the job B is set at “5” in order to execute the job X and the job G. As illustrated in FIG. 6B, the fact that the job B was suspended and the priority of the job B was “6” at that time is recorded in the item “job to be resumed” of information corresponding to the jobs X and G in the job management information.

In this case, the execution control portion 125e gives an Instruction to the suspended job resuming portion 125g both at the time point of completion of execution of the job G and at the time point of completion of execution of the job X to assign the computing nodes used in the completed jobs to the processes of the job B. When the computing nodes have been assigned to all the processes of the job B, the suspended job resuming portion 125g updates the status of the job B to “running” and restores the priority from “5” to “6” in the job management information.

The simulation portion 125h is a processing portion for simulating an execution state of each job and outputting a result of the simulation to the display portion 123, etc. In order to simulate the execution state of the job accurately, the simulation portion 125h calls and uses processing logics of the priority execution portion 125b, the suspended job selection portion 125c, the free node-using job selection portion 125d, the priority adjustment portion 125f, the suspended job resuming portion 125g, etc. if occasion demands.

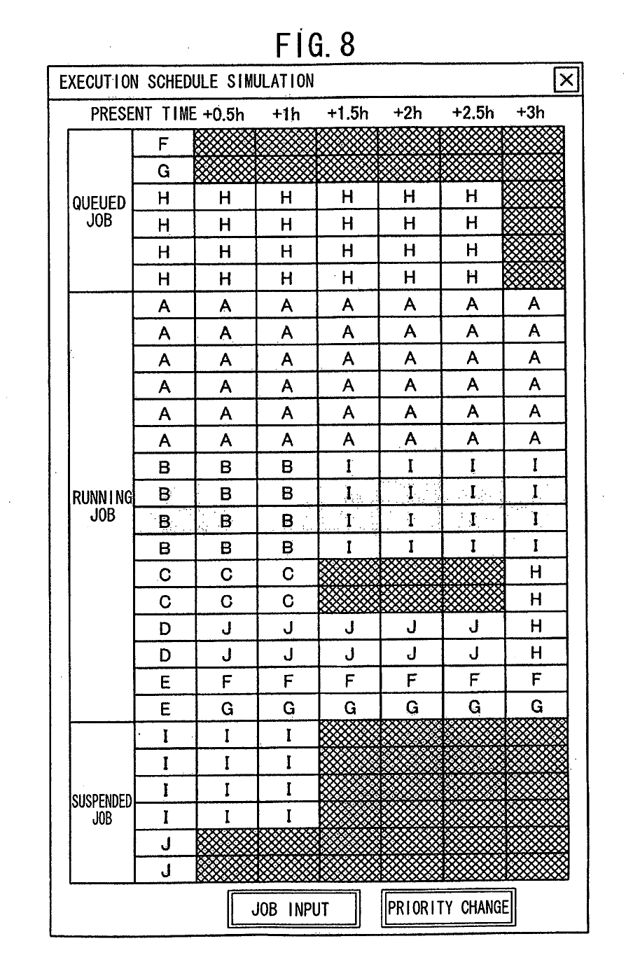

FIG. 8 illustrates an example of an output screen of the simulation portion 125h. As illustrated in FIG. 8, changes of queued jobs, running jobs and suspended jobs every 30 min are expressed graphically on the output screen. Referring to this output screen, for example, a manager or the like can find that two computing nodes are in an idle state in a period between 1.5 hours later and 3 hours later from now, and can grasp that there is still room to execute a job requiring two or less computing nodes and having the time of 90 min or less required for execution in the period.

A user can virtually execute an operation of Inputting a new job or changing priority of any job at any time point on this output screen, so that the simulation portion 125h executes the simulation again in accordance with a result of the operation and displays a result of the simulation again.

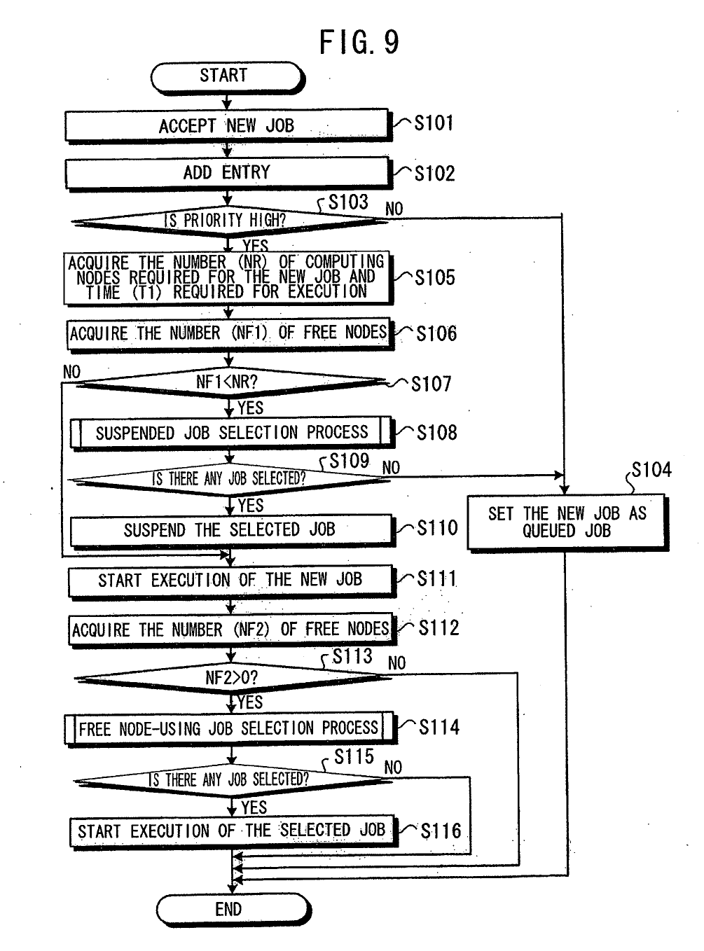

Next, a processing procedure of the job management apparatus 12 illustrated in FIG. 5 will be described. FIG. 9 illustrates a processing procedure of acceptance when a new job is input into the job management apparatus 12. As illustrated in FIG. 9, upon acceptance of the new job (operation S101), the acceptance portion 125a adds an entry to the job management information illustrated in FIG. 6A and sets information about the job (operation S102). When the priority of the job is not high (No in operation S103), the acceptance portion 125a stores the job as an ordinary queued job in the queued job storage area 121a (operation S104).

On the other hand, when the priority of the new job is high (Yes in operation S103), the acceptance portion 125a instructs the priority execution portion 125b to execute the job preferentially. Upon reception of the instruction, the priority execution portion 125b acquires the number NR of computing nodes required for the new job and the time T1 required for execution from the job management information (operation S105) and acquires the number NF1 of current free nodes from the job assignment information (operation S106).

When NF1 is smaller than NR, i.e. when the number of free nodes is smaller than the number of nodes required for the new job (Yes in operation S107), the priority execution portion 125b controls the suspended job selection portion 125c to execute a suspended job selection process which will be described later (operation S108). When a job to be suspended is selected (Yes in operation S109), the priority execution portion 125b suspends the selected job (operation S110). Incidentally, when the suspended job selection portion 125c does not select any job to be suspended (No in operation S109), the priority execution portion 125b stores the new job as an ordinary queued job in the queued job storage area 121a and terminates the processing (operation S104).

After the selected job is suspended, the priority execution portion 125b assigns computing nodes to the new job for starting execution of the new job and reflects this state in the job management information and the job assignment information (operation S111). The priority execution portion 125b acquires the number NF2 of current free nodes from the job assignment information (operation S112). When NF2 is 0, i.e. when there is no free node (No in operation S113), the priority execution portion 125b terminates the processing.

When NF2 is larger than 0, i.e. when there is any free node (Yes in operation S113), the priority execution portion 125b controls the free node-using job selection portion 125d to execute a free node-using job selection process which will be described later (operation S114). When a free node-using job has been selected (Yes in operation S115), the priority execution portion 125b assigns computing nodes to the selected job for starting execution of the job and reflects this state in the job management information and the job assignment information (operation S116). Incidentally, when the free node-using job selection portion 125d does not select any free node-using job (No in operation S115), the priority execution portion 125b terminates the processing directly.

When NF1 is not smaller than NR in the operation S107, i.e. when the number of free nodes is not smaller than the number of nodes required for the new job (No in operation S107), the priority execution portion 125b does not suspend any job but executes processes in and after the operation S111.

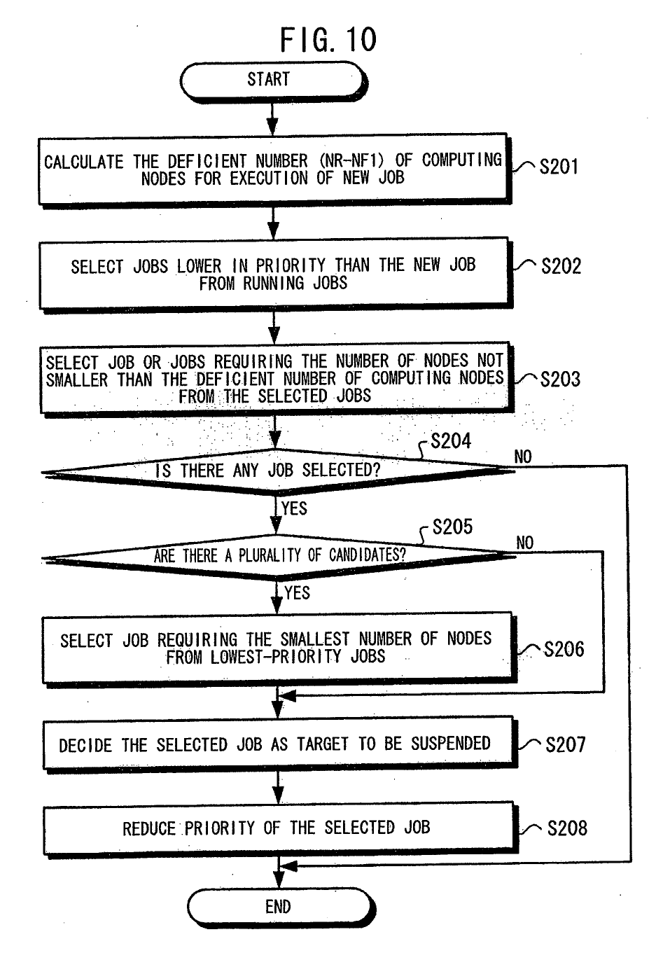

FIG. 10 illustrates a processing procedure of the suspended job selection process. As illustrated in FIG. 10, the suspended job selection portion 125c calculates a difference between NR and NF1 to obtain the deficient number of computing nodes for execution of the new job (operation S201). The suspended job selection portion 125c selects jobs lower in priority than the new job from “running” jobs by referring to the job management information (operation S202). The suspended job selection portion 125c further selects a job or jobs requiring a number of assigned computing nodes not smaller than the deficient number of computing nodes obtained in the operation S201, from the selected jobs (operation S203).

When there is any job selected and there are selected candidates (Yes in operation S204 and Yes in operation S205), the suspended job selection portion 125c selects lowest-priority jobs from the selected jobs and further selects one job requiring the smallest number of nodes from the selected lowest-priority jobs (operation S206). The suspended job selection portion 125c decides the selected job as a target to be suspended (operation S207) and resets the priority of the selected job at a lower value than the priority of any other queued job (operation S208).

On the other hand, when there is any job selected and there is one selected candidate (Yes in operation S204 and No in operation S205), the suspended job selection portion 125c decides the selected job as a target to be suspended (operation S207) and resets the priority of the selected job at a lower value than the priority of any other queued job (operation S208). When there is no job selected in the operation S203 (No in operation S204), the suspended job selection portion 125c does not decide the target to be suspended but terminates the processing.

Although the aforementioned processing procedure has been described in the example in which only one single job is selected as a target to be suspended, the processing procedure can be changed so that a combination of jobs can be selected as targets to be suspended when a table for all combinations of selected jobs is generated and a combination the total number of assigned computing nodes of which is not smaller than NR is selected from the table in the operation S203.

Although the aforementioned processing procedure has been described in an example in which a target to be suspended is selected in order to reduce the number of processes to be suspended, the target to be suspended may be selected to minimize the total amount of idle times of computing nodes if the following processing is performed in the operation S206. That is, a table for all combinations of selected jobs and queued jobs the number of computing nodes required for execution of each of which is not larger than the number of free nodes formed when the job is selected as a target to be suspended may be generated so that a running job corresponding to a combination which will result in the smallest total amount of idle times of computing nodes can be selected as a target to be suspended from all the combinations. The job mentioned herein may be a combination of jobs.

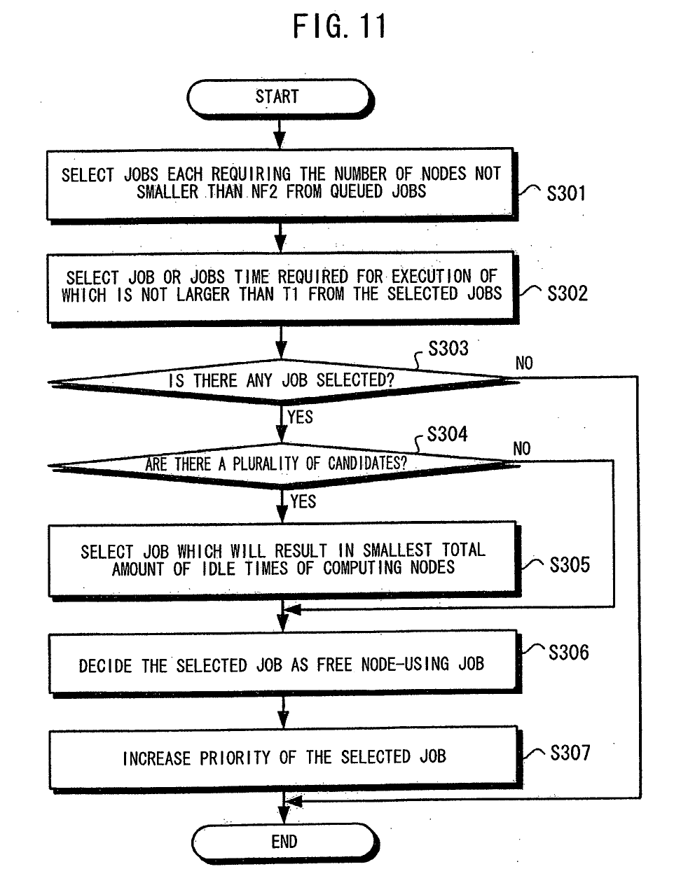

FIG. 11 illustrates a processing procedure of a free node-using job selection process. As illustrated in FIG. 11, the free node-using job selection portion 125d selects jobs each requiring the number of free nodes not larger than NF2 from “queued” jobs by referring to the job management information (operation S301) and further selects a job or jobs the time required for of execution of which is not longer than T1, from the selected jobs (operation S302).

When there is any job selected and there are a plurality of selected candidates (Yes in operation S303 and Yes in operation S304), the free node-using job selection portion 125d selects one job from the selected jobs so that the total amount of idle times of computing nodes becomes smallest when the job is set as a free node-using job (operation S305). The free node-using job selection portion 125d decides the selected job as a free node-using job (operation S306) and resets the priority of the selected job at a higher value than the priority of any other running job (operation S307).

On the other hand, when there is any job selected and there is one selected candidate (Yes in operation S303 and No in operation 8304), the free node-using job selection portion 125d decides the selected job as a free node-using job (operation S306) and resets the priority of the selected job at a higher value than the priority of any other running job (operation S307). When there is no job selected in the operation S302 (No in operation S303), the free node-using selection portion 125d does not decide any free node-using job but terminates the processing.

Although the aforementioned processing procedure has been described in the example where only one single job is selected as a free node-using job, the processing procedure may be changed so that a combination of jobs can be selected as free node-using jobs if a table for all combinations of selected jobs are generated and one combination which will result in the smallest total amount of idle times of computing nodes when the combination is set as free node-using jobs is selected from the table in the operation 305.

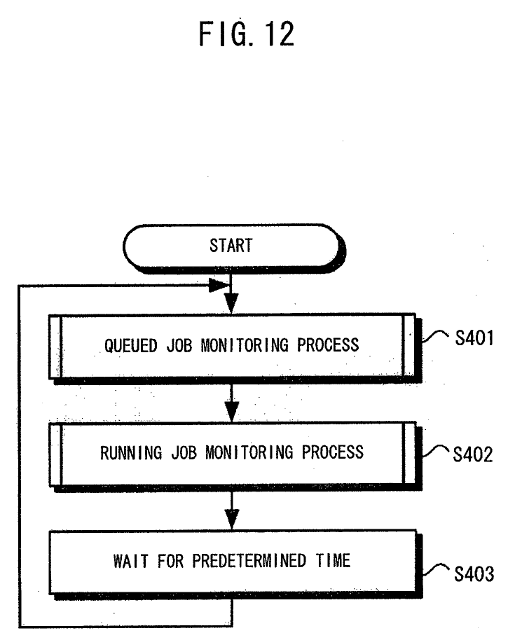

FIG. 12 illustrates a processing procedure of job management of the execution control portion 125e. As illustrated in FIG. 12, the execution control portion 125e repetitively executes a processing procedure as follows. That is, the execution control portion 125e executes a queued job monitoring process (which will be described later) after the job management apparatus 12 starts its operation (operation S401). Then, the execution control portion 125e executes a running job monitoring process (which will be described later) (operation S402). After waiting for a predetermined time (operation S403), the execution control portion 125e executes the queued job monitoring process and the running job monitoring process again.

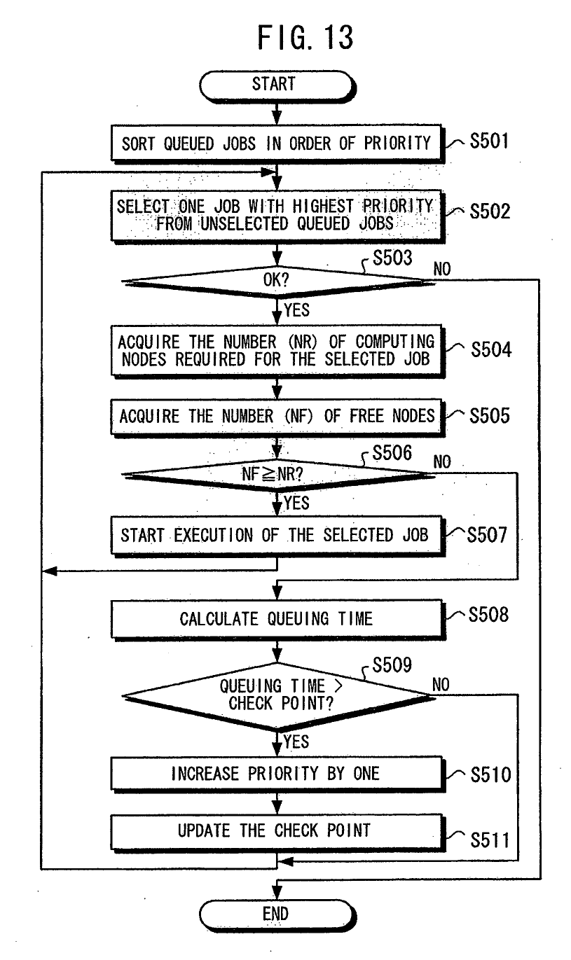

FIG. 13 illustrates a processing procedure of the queued job monitoring process. As illustrated in FIG. 13, the execution control portion 125e acquires information of “queued” jobs from the job management information, and sorts these acquired jobs in order of priority (operation S501). The execution control portion 125e selects an unselected and highest-priority job from the sorted jobs (step S502). When there is one job selected (Yes in step S503), the execution control portion 125e acquires the number NR of computing nodes required for the selected job (operation S504) and further acquires the number NF of current free nodes from the job assignment information (operation S505).

When NF is not smaller than NR, that is, when the number of free nodes for execution of the selected job is sufficient (Yes in operation S506), the execution control portion 125e assigns computing nodes to the selected job for starting execution of the job and reflects this state in the job management information and the job assignment information (operation S507). After that, the execution control portion 125e goes back to the operation S502 for an attempt to select a next job.

On the other hand, when NF is smaller than NR, that is, when the number of free nodes for execution of the selected job Is not sufficient (No in operation S506), the execution control portion 125e calculates the queuing time of the selected job (operation S508). When the queuing time is larger than the value at the check point (Yes in operation S509), the execution control portion 125e controls the priority adjustment portion 125f to adjust priority. The priority adjustment portion 125f increases the priority of the job by one (operation S510) and updates the value at the check point (operation S511). After processing of the priority adjustment portion 125f is finished, the execution control portion 125e goes back to the operation S502 for an attempt to select a next job.

When there is no job selectable in the operation S502 because all jobs have been already selected (No in operation S503), the execution control portion 125e terminates the processing.

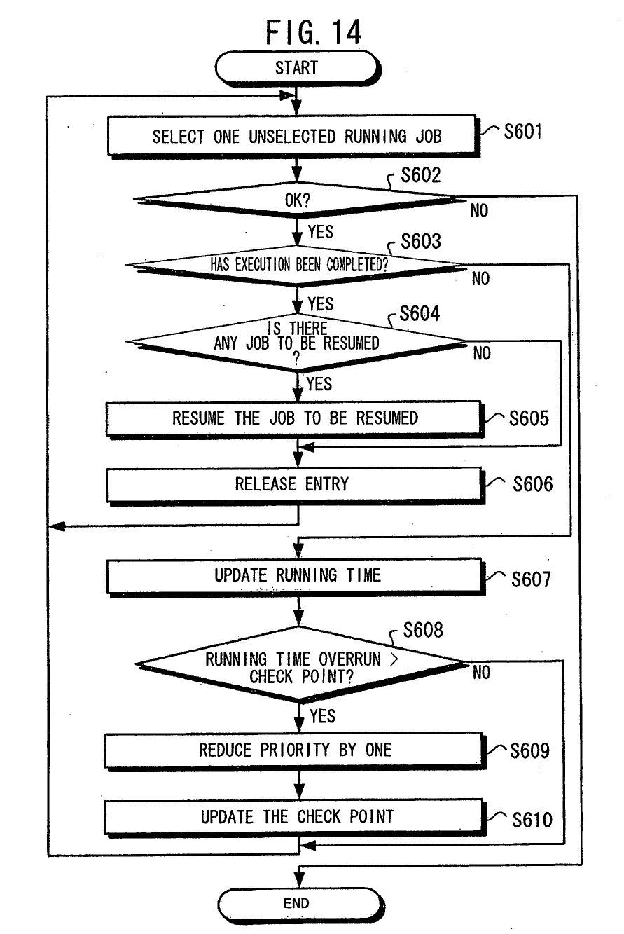

FIG. 14 illustrates a processing procedure of the running job monitoring process. As illustrated in FIG. 14, the execution control portion 125e selects an unselected “running” job by referring to the job management information (operation S601). When there is one job selected (Yes in operation S602), the execution control portion 125e checks the execution state of the job.

When execution of the job has been completed (Yes in operation S603), the execution control portion 125e controls the suspended job resuming portion 125g to resume a job (operation S605) if there is any job needing to be resumed (Yes in operation S604). The execution control portion 125e deletes the entry of the completed job in the job management information and deletes information of the completed job in the job assignment information regardless of presence/absence of the job needing to be resumed (operation S606). After that, the execution control portion 125e goes back to the operation S601 for an attempt to select a next job.

On the other hand, when execution of the job selected in the operation S601 has not been completed (No in operation S603), the execution control portion 125e updates the running time of the job in the job management information (operation S607). The execution control portion 125e calculates the running time overrun of the selected job. When the running time overrun is larger than the value at the check point (Yes in operation S608), the execution control portion 125e controls the priority adjustment portion 125f to adjust priority. The priority adjustment portion 125f reduces the priority of the job by one (operation S609) and updates the value at the check point (operation S610). After processing of the priority adjustment portion 125f is finished, the execution control portion 125e goes back to the operation S601 for an attempt to select a next job.

When there is no job selectable in the operation S601 because all jobs have been already selected (No in operation S602), the execution control portion 125e terminates the processing.

The configuration of the job management apparatus 12 according to an embodiment as illustrated in FIG. 5 can be changed variously. For example, the function of the control portion 125 of the job management apparatus 12 may be provided as software and executed on a computer so that a function equivalent to that of the job management apparatus 12 can be achieved. An example of a computer for executing a job management program 1071 having the function of the control portion 125 provided as software will be described below.

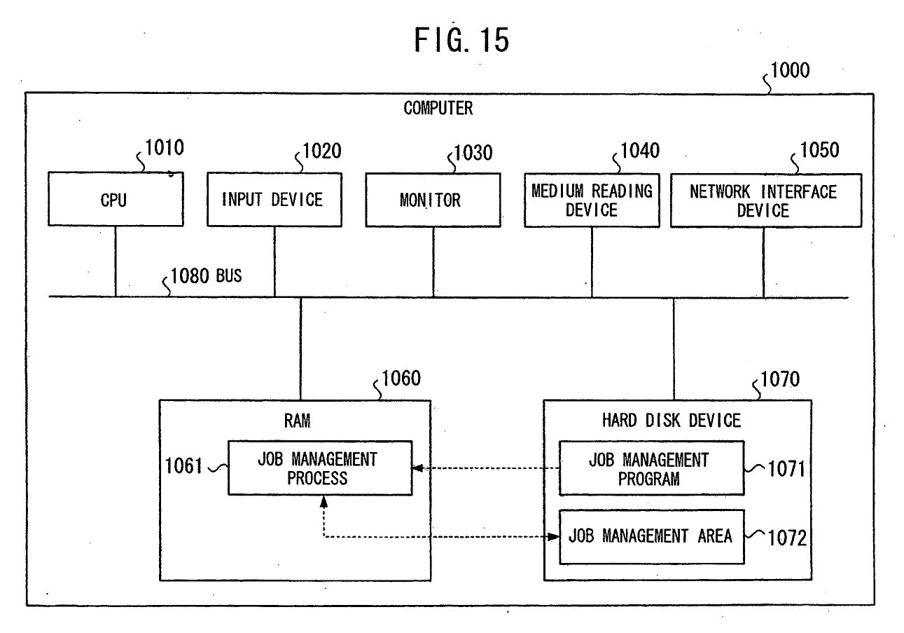

FIG. 15 illustrates a computer 1000 for executing the job management program 1071. This computer 1000 includes a CPU (Central Processing Unit) 1010 for executing various kinds of arithmetic operations, an input device 1020 for accepting input of data from a user, a monitor 1030 for displaying various kinds of information, a medium reading device 1040 for reading a program etc. from a recording medium, a network interface device 1050 for exchanging data with another computing through a network, an RAM (Random Access Memory) 1060 for temporarily storing various kinds of information, and a hard disk device 1070. These constituent parts 1010 to 1070 may be connected to one another by a bus 1080.

The job management program 1071 performing as a of the control portion 125 illustrated in FIG. 5 may be stored in the hard disk device 1070. A job management area 1072 equivalent to the storage portion 121 illustrated in FIG. 5 may be provided in the hard disk device 1070. The job management area 172 may be dispersed properly and provided in other computers connected to the computer by the network.

When the CPU 1010 reads the job management program 1071 from the hard disk device 1070 and expands the job management program 1071 into the RAM 1060, the job management program 1071 may conduct a job management process 1061. The job management process 1061 expands information, etc. read from the job management area 1072 into a suitably assigned area on the RAM 1060 and executes various kinds of data processing based on the expanded data, etc.

The aforementioned job management program 1071 need not be stored in the hard disk device 1070. For example, this program may be stored in a recording medium such as a CD-ROM so that the computer 1000 can read this program from the recording medium and execute this program. For example, this program may be stored in advance in other computers (or servers) connected to the computer 1000 through a public line, the Internet, an LAN (Local Area Network), a WAN (Wide Area Network), etc. so that the computer 1000 can read this program from the other computers and execute this program.

As described above, an embodiment when a new job with high priority is accepted, a job running by using a number of computing nodes not smaller than the deficient number of computing nodes for execution of the new job may be suspended so that the computing nodes used in the suspended job and free nodes can be used for execution of the new job. Accordingly, it is possible to prevent such a situation that, because part of processes of a running job are suspended, the other part of the processes of the job are brought into a state equal to the suspended state while computing nodes are still assigned to the other part of the processes. Thus, it is possible to efficiently use computing nodes included in the cluster.

In addition, the embodiment is designed so that free nodes generated due to execution of a new job are used to execute a job which will be completed earlier than the new job. Accordingly, it is possible to efficiently use computing nodes included in the cluster without delaying the time for resuming a suspended job after completion of execution of the new job.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method for job management of a computer system by a computer, comprising:
selecting, as a second job, a running job which is lower in priority than a first job and a number of computing nodes required for execution of which is not smaller than a deficient number of computing nodes due to execution of the first job when a number of free computing nodes in a cluster of the computer system is smaller than a number of computing nodes required for the first job;
suspending all processes of the second job and executing the first job in the computing nodes which were used by the second job and the free computing nodes; and
resuming execution of the second job after execution of the first job is completed.

2. The method according to claim 1, further comprising:
selecting, as a third job, a job the number of computing nodes required for execution of which is not larger than a number of free nodes, a time required for execution of which is not longer than a time required for execution of the first job, and which is not running in the cluster, when the free nodes are present in the cluster after start of execution of the first job in the priority execution; and
executing the third job in the free computing nodes.

3. The method according to claim 1, wherein when there are a plurality of choices for the second job, the job with lowest priority or the job having the smallest number of computing nodes required for execution is selected as the second job from the choices of the second job in the suspended job selection.

4. The method according to claim 1, wherein when there are jobs each of which is lower in priority than the first job and the number of computing nodes required for execution of each of which is not smaller than the deficient number of computing nodes due to execution of the first job, a job which will result in a smallest total amount of idle times of computing nodes included as free nodes in the cluster up to resume of execution of the second job is selected as the second job from these jobs in the suspended job selection.

5. The method according to claim 1, wherein priority of the selected second job is reduced in the suspended job selection.

6. The method according to claim 2, wherein priority of the selected third job is increased in the free node-using job selection.

7. The method according to claim 1, further comprising:
reducing priority of a job when a running time of the job exceeds a designated time required for execution by a predetermined time or longer.

8. The method according to claim 1, further comprising:
increasing priority of a job when a queuing time of the job before execution in the cluster exceeds a predetermined time after acceptance of the job.

9. A job management system comprising:
a suspended job selecting unit which selects, as a second job, a running job which is lower in priority than a first job and a number of computing nodes required for execution of which is not smaller than a deficient number of computing nodes due to execution of the first job when a number of free computing nodes in a cluster of a computer system is smaller than a number of computing nodes required for the first job;
a priority execution unit which suspends all processes of the second job and executes the first job in the computing nodes which were used by the second job and the free computing nodes; and
a resuming unit which resumes execution of the second job after completion of execution of the first job.

10. A computer-readable recording medium encoded with a computer program that causes a computer to execute processing for a job management system, comprising:
selecting, as a second job, a running job which is lower in priority than a first job and a number of computing nodes required for execution of which is not smaller than a deficient number of computing nodes due to execution of the first job when a number of free computing nodes in a cluster of a computer system is smaller than a number of computing nodes required for the first job;
suspending all processes of the second job and executing the first job in the computing nodes which were used by the second job and the free computing nodes; and
resuming execution of the second job after completion of execution of the first job.

11. A job management apparatus comprising:
a suspended job selecting unit which selects a running job, which is lower in priority than a first job, as a second job and a number of computing nodes required for execution of which is equal to or greater than a deficient number of computing nodes due to execution of the first job when a number of free computing nodes is less than required for the first job; and
a priority execution unit that suspends processes of the second job and executes the first job in the computing nodes that were used by the second job and the free computing nodes.
